(19) United States
(12) Patent Application Publication
(10) Pub. No.: US 2001/0001026 A1
(43) Pub. Date: May 10, 2001

(54) Knocking writing utensil

(76) Inventors: Hidehei Kageyama, Kawagoe-shi (JP); Yoshio Noguchi, Kawagoe-shi (JP)

Correspondence Address: MCGINN & GIBB, PLLC, 8321 OLD COURTHOUSE ROAD, SUITE 200, VIENNA, VA, 22182-3817, US

(21) Appl. No.: 09/742,108

(22) Filed: Dec. 22, 2000

Related U.S. Application Data
(62) Division of application No. 09/361,204, filed on Jul. 27, 1999.

(30) Foreign Application Priority Data
Jul. 27, 1998 (JP) 10-211655
Jul. 5, 1999 (JP) 11-190931

(51) Int. Cl. B43K 5/16; B43K 7/12; B43K 24/02

(52) U.S. Cl. 401/104; 401/99; 401/112

(57) ABSTRACT

A knocking writing utensil which automatically returns a writing medium to a withdrawn position when a clip is used, includes an engagingly-locking protrusion formed on an engagement body that moves inside an external cylinder together with a refill. An engaging-lock receiving protruding portion including an engaging-lock receiving portion at its front end is formed on the rear surface of a non-proximal end of a clip with its proximal end fixed to the external cylinder. A guide hole is formed in the external cylinder so as to correspond to the engaging-lock receiving protruding portion. A cam portion for abutting on the engagingly-locking protrusion is formed on a knock bar integrated with a knock body. The cam portion moves the engagingly-locking protrusion beyond the engaging-lock receiving protruding portion from behind it to the engaging-lock receiving portion, or guides the engagingly-locking protrusion from the engaging-lock receiving portion to behind the engaging-lock receiving protruding portion so as to pass by one lateral side of the engaging-lock receiving protruding portion.

### BACKGROUND OF THE INVENTION

1. 1. Field of the Invention

2. The present invention relates to a knocking writing utensil such as a ball-point pen, a mechanical pencil, or a marker, that uses a knocking operation to move a writing medium to a forward position in which the tip of the writing medium protrudes from the tip of an external cylinder.

3. 2. Description of the Related Art

4. A conventional knocking writing utensil includes an external cylinder, a writing medium inserted and housed in the external cylinder so as to be moved in the axial direction, an elastic body for urging the writing medium rearward, a clip with its proximal end fixed to the external cylinder, and a knock body that is exposed outwardly from the external cylinder to be easily knocked (e.g., actuated, depressed, etc.). The knock body is operated to move the writing medium from a withdrawn position within the external cylinder to a forward position where the writing medium tip protrudes from the tip of the external cylinder.

5. If a user forgets to withdraw the writing medium into the external cylinder and clips the conventional writing utensil to the edge of their jacket pocket for instance, then the writing medium may stain their clothing or make a hole therein.

6. A knocking writing utensil that solves this problem is described in the applicant's Japanese Utility Model Publication No. 5-25915 and Japanese Utility Model Publication No. 6-15735.

7. In these knocking writing utensils, a clip is integrated with a knock body protruding from the rear end portion of an external cylinder. An engagingly-locking protrusion is provided on the rear surface of the tip of the clip so as to engage an engaging-lock receiving portion formed on the external cylinder to hold a writing medium at a forward position.

8. In this knocking writing utensil, when the user attempts to separate the tip of the clip from the external cylinder, in order to insert the clip on a pocket, the engagingly-locking protrusion is disengaged from the engaging-lock receiving portion to automatically withdraw the writing medium. This prevents a garment, and an attached pocket, from being stained or damaged. However, since the clip moves in response to the knocking of the knock body, knocking the knock body is impossible while the clip is in a gripping position. Thus, with this type of writing utensil, a knocking operation is difficult.

9. Furthermore, to return the writing medium to the withdrawn position, both ends of the clip must be rocked up and down, and the knocking operation of the knock body does not allow the writing medium to return to its housed (withdrawn) position. Thus, different operations are required to extend the writing medium and to withdraw it. Therefore, another problem is that the operation of withdrawing the writing medium and the knocking operation are not simple, but instead are unduly complicated.

### SUMMARY OF THE INVENTION

10. In view of the foregoing and other problems, disadvantages, and drawbacks of the conventional knocking writing utensil, an object of the present invention is to provide a knocking writing utensil that facilitates a simple knocking operation and that enables the writing medium to automatically return to a withdrawn position when the clip is used.

11. To attain the above and other objects, a knocking writing utensil according to the invention, includes an external cylinder, a writing medium inserted and housed in the external cylinder so as to be movable in the axial direction, an elastic body for propelling the writing medium rearward, and a knock body that protrudes from the external cylinder to be knocked. In a knocking operation, the knock body is knocked (e.g., actuated, depressed, etc.) to move the writing medium between a withdrawn position within the external cylinder and a forward position where the writing medium tip protrudes from the tip of the external cylinder.

12. In the writing utensil, an engagement body for positioning the writing medium is preferably provided within the external cylinder. The engagement body has an engagingly-locking protrusion formed thereon. An engaging-lock receiving protruding portion, including an engaging-lock receiving portion at its front end, is formed on a back surface of a non-proximal end of a clip having its proximal end fixed to the external cylinder.

13. The external cylinder has a guide hole formed to correspond to the engaging-lock receiving protruding portion of the clip. The guide hole preferably is wider than the engaging-lock receiving protruding portion in only one lateral side of the hole relative to the engaging-lock receiving protruding portion.

14. The engagingly-locking protrusion of the engagement body engages the engaging-lock receiving portion of the clip through the guide hole to hold the writing medium at the forward position. The engagingly-locking protrusion disengages from the engaging-lock receiving portion and is placed behind the engaging-lock receiving protruding portion to hold the writing medium at the withdrawal position.

15. In the writing utensil, a knock bar is disposed inside the external cylinder. The knock bar is integratedly operated with the knock body, and has a cam portion that can be engaged with the engagement body.

16. The cam portion guides the engagingly-locking protrusion beyond the engaging-lock receiving protruding portion, from behind it, to the engaging-lock receiving portion. The cam portion also guides the engagingly-locking protrusion from the engaging-lock receiving portion to a position behind the engaging-lock receiving protruding portion, so as to pass by one lateral side of the engaging-lock receiving protruding portion.

17. In a writing operation, when the knock body is operated, the cam portion of the knock bar, integratedly operated with the knock body, engages the engagement body, to press the engagingly-locking protrusion of the engagement body forward against the resisting force of the elastic body.

18. The cam portion of the knock bar moves the engagingly-locking protrusion from behind, beyond the engaging-lock receiving protruding portion of the clip to the engaging-lock receiving portion located at the front end of the engaging-lock receiving protruding portion.

19. In this manner, the engagingly-locking protrusion engages with the engaging-lock receiving portion to hold the writing medium at the forward position such that its tip protrudes from the tip of the external cylinder. Thus, writing is possible.

20. When not writing, the knock body is operated again to make the cam portion of the knock bar engage with the engaging body so that, based on the urging force of the cam portion and elastic body, the engagingly-locking protrusion is moved from the engaging-lock receiving portion to behind the engaging-lock receiving protruding portion so as to bypass the engaging-lock receiving protruding portion.

21. Then, the engagingly-locking protrusion is disengaged from the engaging-lock receiving portion and placed behind the engaging-lock receiving protruding portion to hold the writing medium at the withdrawal position at which it is withdrawn into the external cylinder.

22. Optionally, the cam portion of the knock bar can engage the engagingly-locking protrusion of the engagement body. The cam portion of the knock bar has a first cam surface that guides the engagingly-locking protrusion from behind to a position beyond the engaging-lock receiving protruding portion to the engaging-lock receiving portion. The cam portion of the knock bar also has a second cam surface that guides the engagingly-locking protrusion from the engaging-lock receiving portion to behind the engaging-lock receiving protruding portion in an operation to pass by one lateral side of the engaging-lock receiving protruding portion. The first and second cam surfaces of the cam portion of the knock bar reliably guide the engagingly-locking protrusion through a predetermined route to prevent malfunction.

23. Optionally, besides the engagingly-locking protrusion, a cam receiving portion that engages with the cam portion of the knock bar can be formed on the engagement body. Since the cam receiving portion, as well as the engagingly-locking protrusion, are formed on the engagement body, the cam portion of the knock bar can stably guide the engagement body.

24. A knocking writing utensil according to another aspect of the present invention includes an external cylinder, a writing medium inserted and housed in the external cylinder so as to be moved in the axial direction, an elastic body for urging the writing medium rearward, and a knock body that is exposed outwardly from the side of the external cylinder to be knocked. The knock body is operated to move the writing medium between a withdrawn position in which it is withdrawn into the external cylinder and a forward position in which the writing medium tip protrudes from the tip of the external cylinder.

25. In the writing utensil, an engagement body, coupled to the writing medium to position it, is provided in the external cylinder and has an engagingly-lock protrusion formed thereon. An engaging-lock receiving protruding portion, having an engaging-lock receiving portion at its front end, is formed on a back surface of a non-proximal end of a clip having its proximal end fixed to the external cylinder.

26. The external cylinder has a guide hole formed therein corresponding to the engaging-lock receiving protruding portion of the clip. The guide hole is wider than the engaging-lock receiving protruding portion in only one lateral side of the hole relative to the engaging-lock receiving protruding portion. The guide hole has, at a front end opposed to the engaging-lock receiving portion, a front-end cam surface that gradually approaches a side where the engaging-lock receiving protruding portion does not exist, toward the front end of the cam surface.

27. The engagingly-locking protrusion is engaged with the engaging-lock receiving portion through the guide hole to hold the writing medium at the forward position, and is disengaged from the engaging-lock receiving portion and placed behind the engaging-lock receiving protruding portion to hold the writing medium in the withdrawal position.

28. The knock body is adapted to being knocked to move the writing medium forward, located at the withdrawal position, against the resisting force of the elastic body and also, to move the engagingly-locking protrusion beyond the engaging-lock receiving protruding portion, from behind it to the engaging-lock receiving portion.

29. Further, the knock body is adapted to being knocked to move the writing medium forward, from its location at the forward position, thereby causing the engagingly-locking protrusion to depart from the engaging-lock receiving portion and then to slide on the front-end cam surface. As a result, the engagingly-locking protrusion moves to a position behind the engaging-lock receiving protruding portion passing by one lateral side of the engaging-lock receiving protruding portion.

30. The knock body is operated to move the writing medium forward, from its location at the withdrawal position, against the resisting force of the elastic body. This moves the engagingly-locking protrusion of the engagement body, coupled to the writing medium, beyond the engaging-lock receiving protruding portion of the clip from behind it to the engaging-lock receiving portion installed at the front end of the engaging-lock receiving protruding portion. In this manner, the engagingly-locking protrusion is engaged with the engaging-lock receiving portion to hold the writing medium at the forward position where its tip protrudes from the tip of the external cylinder. Thus, writing is possible.

31. The knock body is operated to move the writing medium, from its location at the forward position, in a forward direction to cause the engagingly-locking protrusion to depart from the engaging-lock receiving portion and then to slide on the front-end cam surface. This moves the engagingly-locking protrusion to behind the engaging-lock receiving protruding portion so as to bypass the engaging-lock receiving protruding portion. In this manner, the engagingly-locking protrusion is disengaged from the engaging-lock receiving portion and is placed behind the engaging-lock receiving protruding portion, to hold the writing medium at the withdrawal position at which it is withdrawn into the external cylinder.

32. The engagement body may have a slit for bending the engagingly-locking protrusion in the direction of the inner diameter.

33. Upon interfering with (e.g., abutting) the engaging-lock receiving protruding portion of the clip, the engagingly-locking protrusion can be bent in the direction of the inner diameter to bypass the engagingly-lock receiving protruding portion and to move to the front side of the engagingly-lock receiving protruding portion. Then, the operator feels resistance through the knock body to confirm this operation, resulting in improved operability.

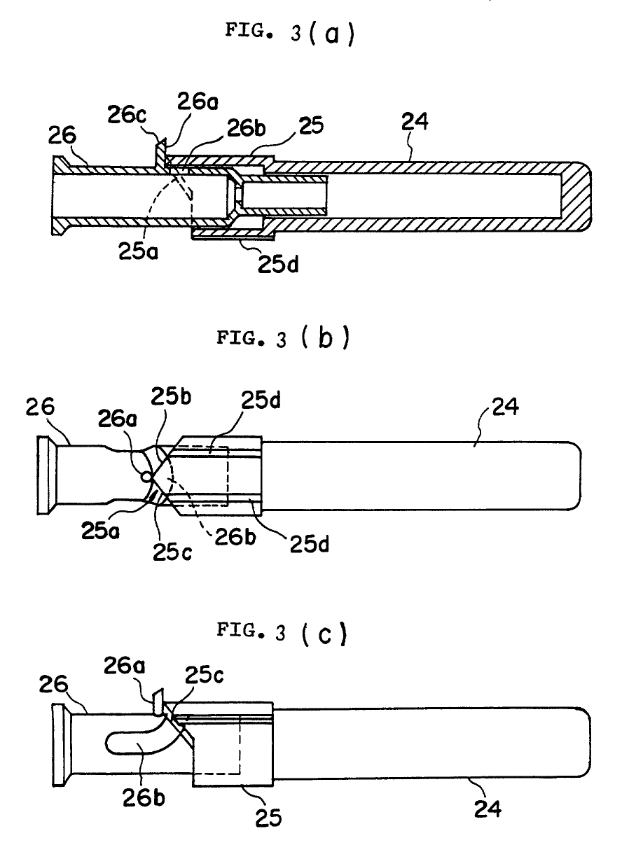

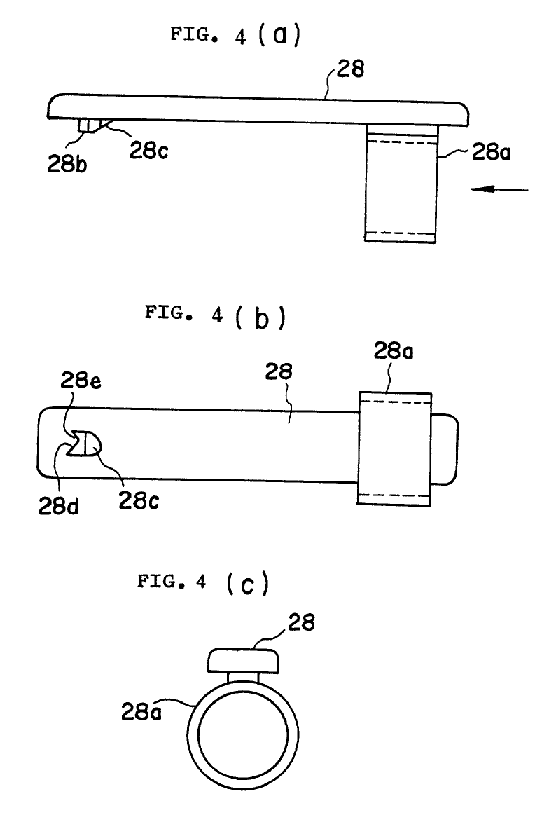

34. The engaging-lock receiving protruding portion may have at its rear an inclined surface (see FIG. 4(c), reference numeral 28c) that is inclined such that its height gradually decreases toward its rear end, and the engagingly-locking protrusion may have at its top an inclined surface (see FIG. 3(a), reference numeral 26c) that is inclined so that its height gradually decreases toward its frond end.

35. When the engagingly-locking protrusion contacts the engagingly-locking receiving protruding portion of the clip, the inclined surfaces of the engaging-lock receiving protruding portion and engagingly-locking protrusion slide across each other while being in contact to smoothly move the engagingly-locking protrusion beyond the engaging-lock receiving protruding portion.

36. The present disclosure relates to subject matter contained in Japanese Patent Application No. Hei 10-211655 and Japanese Patent Application No. Hei 11-190931, filed Jul. 27, 1998, and Jul. 5, 1999, respectively, which are expressly incorporated herein by reference in their entirety.

### BRIEF DESCRIPTION OF THE DRAWINGS

37. The foregoing and other purposes, aspects and advantages will be better understood from the following detailed description of preferred embodiments of the invention with reference to the drawings, in which:

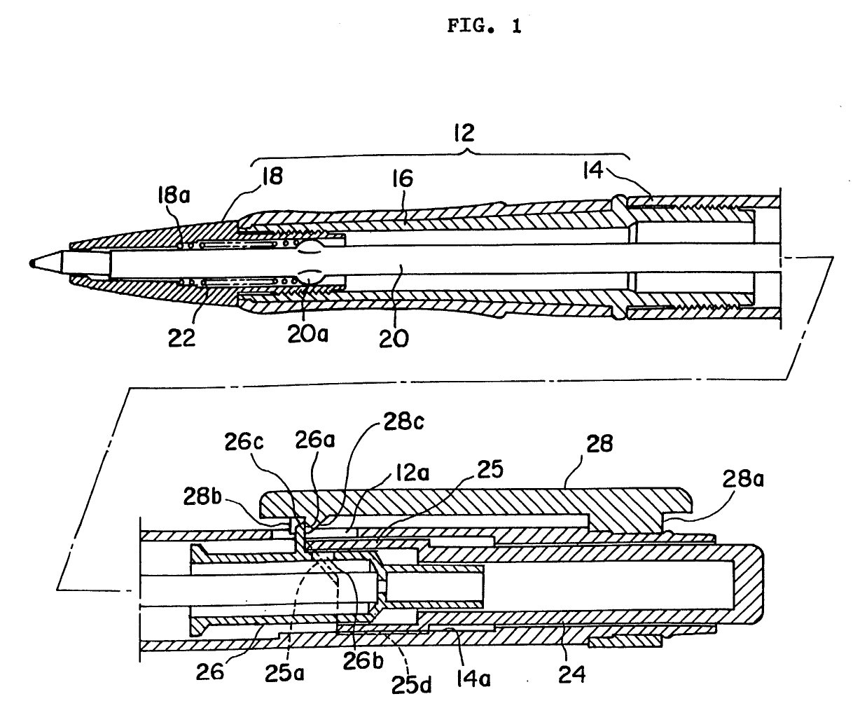

38. FIG. 1 shows a vertical sectional view of a first embodiment of a knocking writing utensil according to the present invention and shows a refill (e.g., a writing medium) at a forward position;

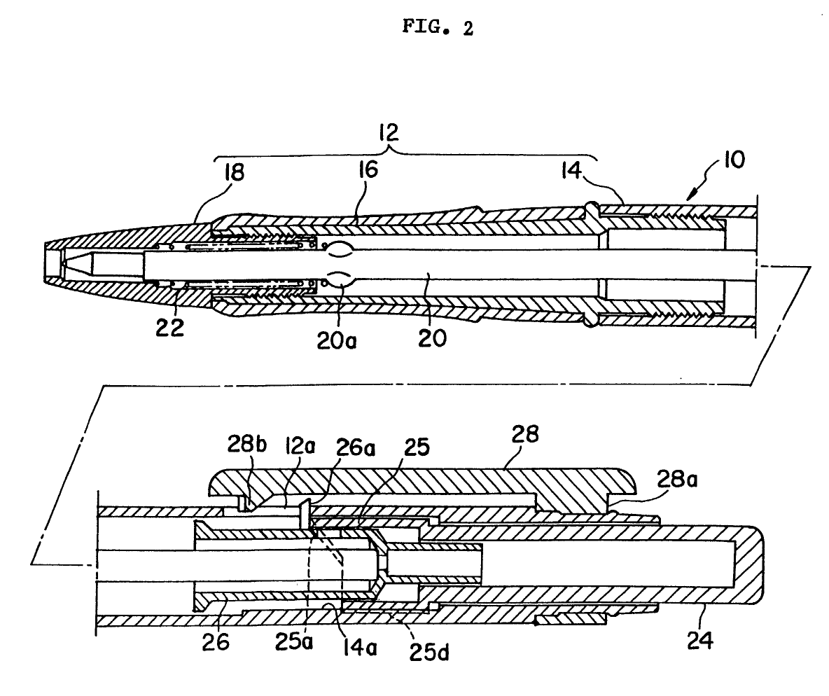

39. FIG. 2 shows a vertical sectional view of the first embodiment of the knocking writing utensil according to the present invention and shows the refill (e.g., the writing medium) at a withdrawal position;

40. FIG. 3(a) shows a sectional view of a knock body and an engagement body according to the first embodiment of the present invention;

41. FIG. 3(b) is a plan view of the knock body and the engagement body according to the first embodiment of the present invention;

42. FIG. 3(c) is a side view of the knock body and the engagement body according to the first embodiment of the invention;

43. FIG. 4(a) is a side view of a clip according to the first embodiment;

44. FIG. 4(b) is a bottom view of the clip according to the first embodiment;

45. FIG. 4(c) is another view of the clip shown in FIG. 4(a) as seen from the direction shown by an arrow;

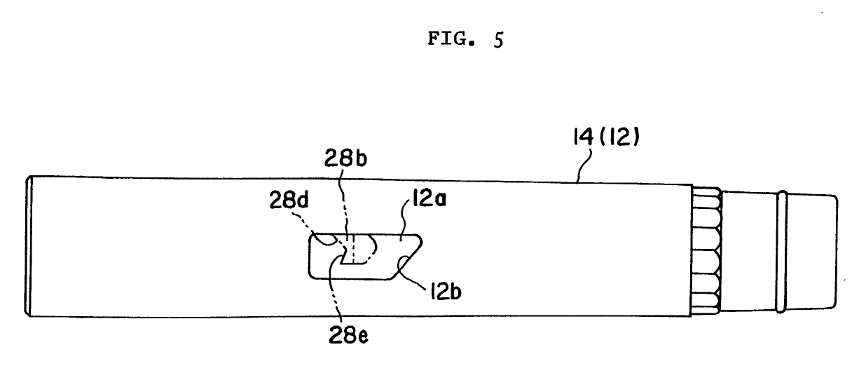

46. FIG. 5 shows a plan view of an external cylinder, (e.g., a rear cylinder) according to the first embodiment;

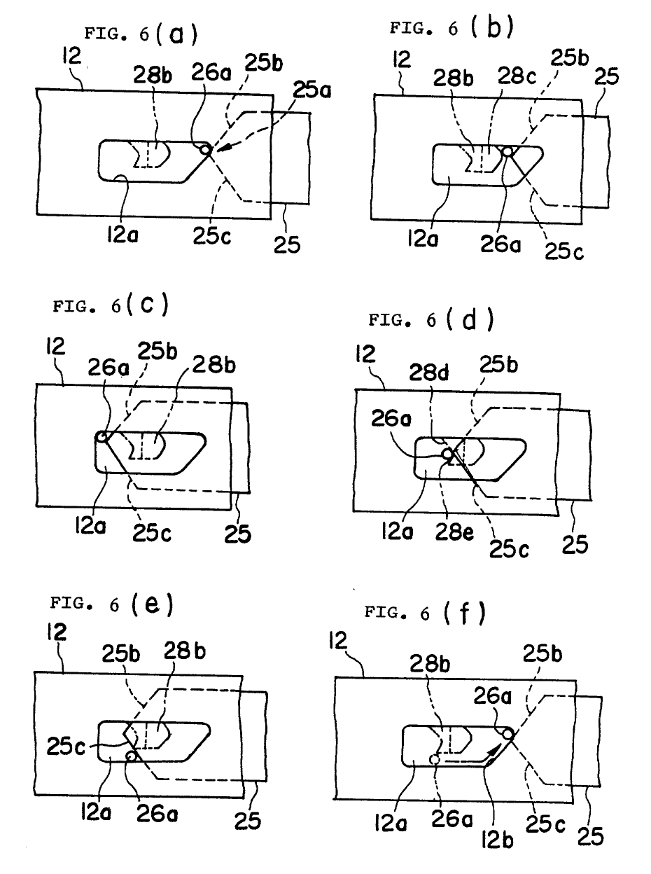

47. FIGS. 6(a) to 6(f) are explanatory drawings showing operations of a guide hole on the external cylinder and an engagingly-locking protrusion thereon according to the first embodiment;

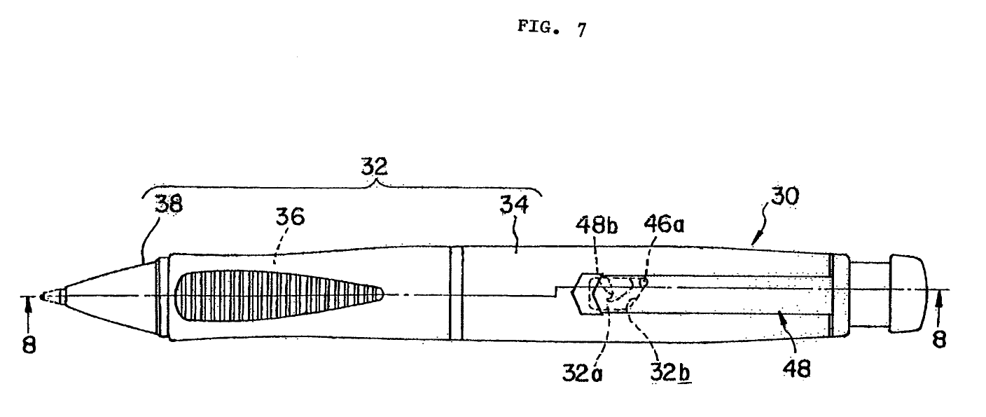

48. FIG. 7 shows a plan view of a second embodiment of the knocking writing utensil according to the present invention;

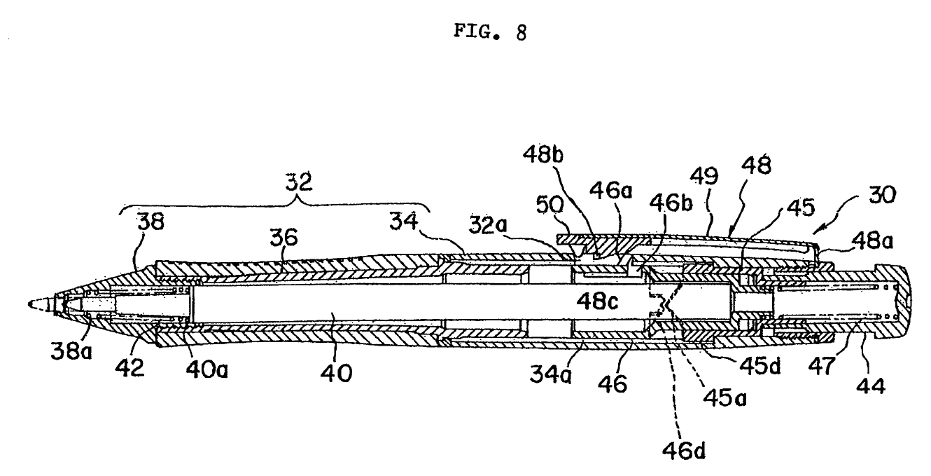

49. FIG. 8 shows a view of the knocking writing utensil according to the present invention taken along a line 8—8 in FIG. 7;

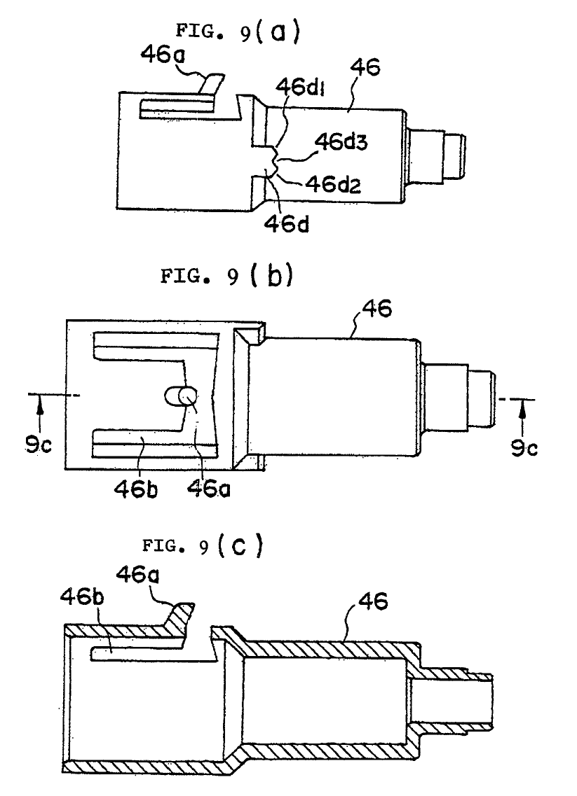

50. FIG. 9(a) is a side view of an engagement body according to the second embodiment of the present invention;

51. FIG. 9(b) is a plan view of the engagement body according to the second embodiment of the present invention;

52. FIG. 9(c) is a sectional view of the engagement body according to the second embodiment of the present invention taken along a line 9c—9c in FIG. 9(b);

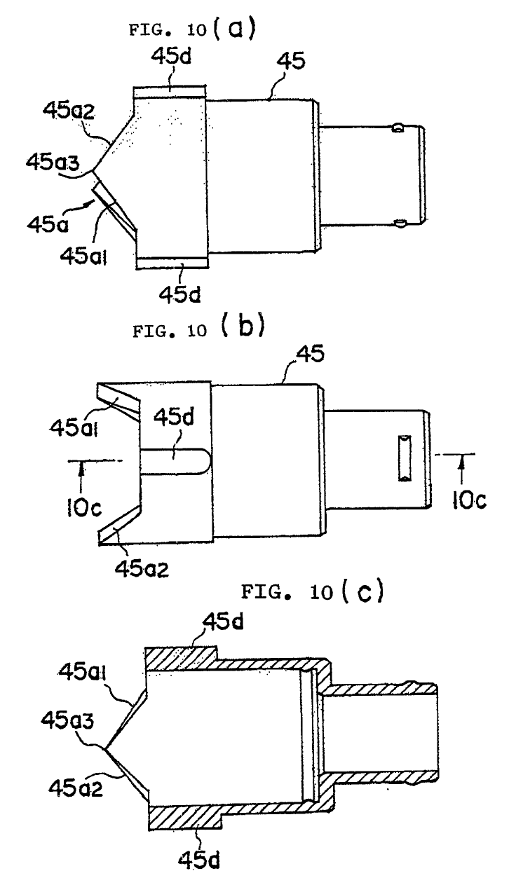

53. FIG. 10(a) shows a side view of a knock bar according to the second embodiment;

54. FIG. 10(b) shows a plan view of the knock bar according to the second embodiment;

55. FIG. 10(c) shows a sectional view of the knock bar according to the second embodiment taken along a line 10c—10c in FIG. 10(b);

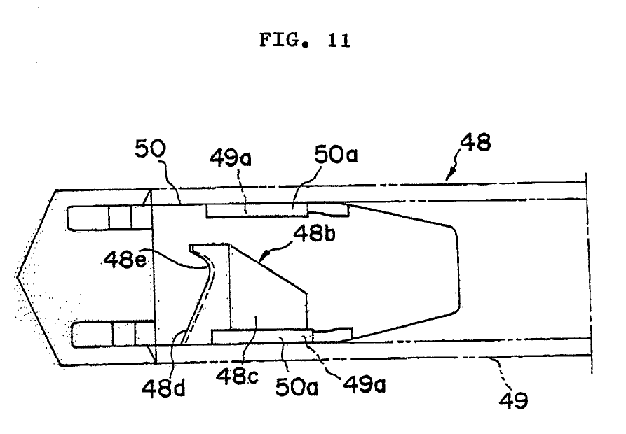

56. FIG. 11 shows the rear surface of a clip according to the second embodiment;

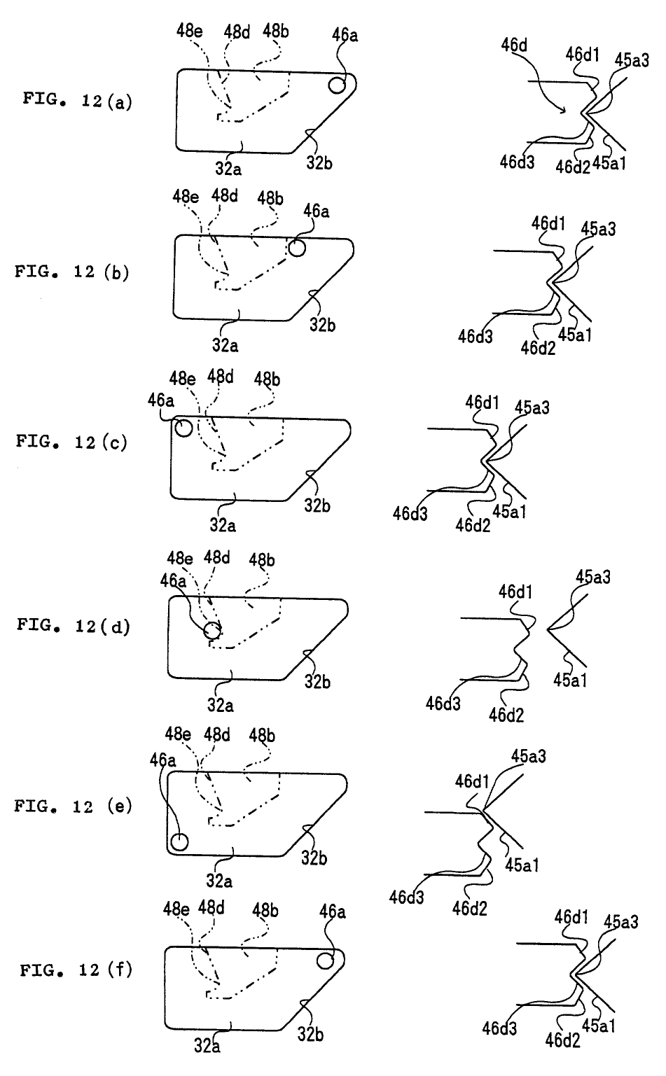

57. FIGS. 12(a) to 12(f) are explanatory drawings showing operations of a guide hole on the external cylinder and an engagingly-locking protrusion thereon according to the second embodiment (e.g., see figures on lefthand side of drawing sheet) as well as operations of a cam receiving portion and a cam portion according to the second embodiment (e.g., see figures on right hand side of drawing sheet);

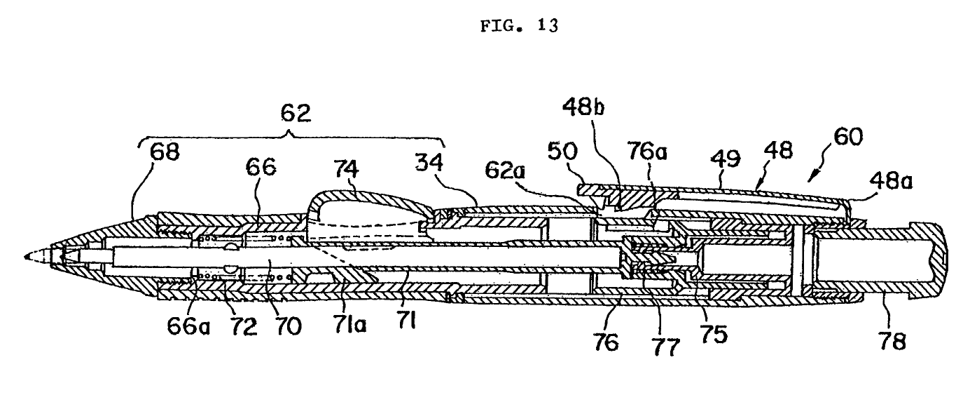

58. FIG. 13 shows a vertical sectional view of a third embodiment of the knocking writing utensil according to the present invention;

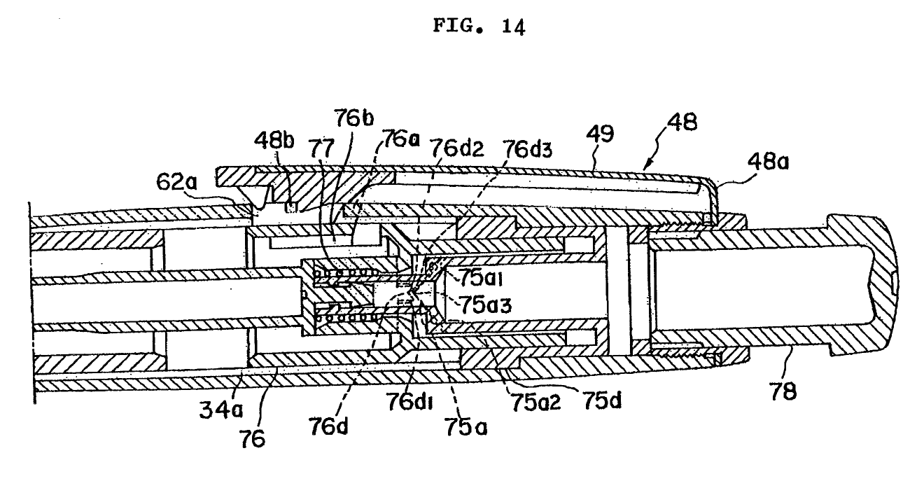

59. FIG. 14 shows a partially enlarged view of a rear portion of FIG. 13;

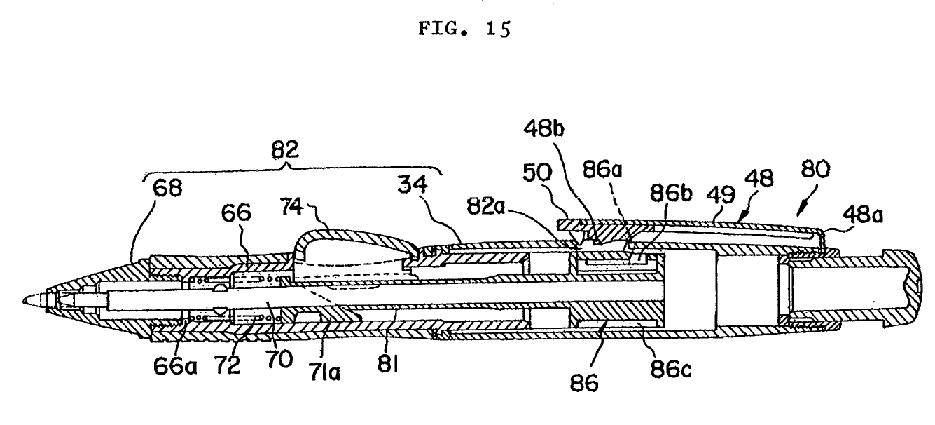

60. FIG. 15 shows a vertical sectional view of a fourth embodiment of the knocking writing utensil according to the present invention;

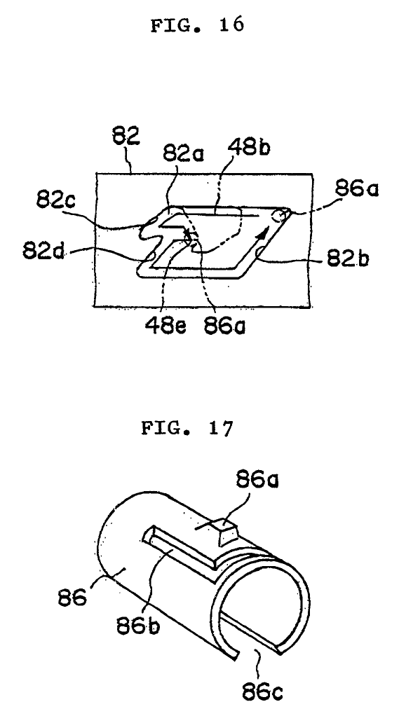

61. FIG. 16 shows a view showing a guide hole in an external cylinder according to the fourth embodiment; and

62. FIG. 17 shows a perspective view showing an engagement body according to the fourth embodiment.

### DESCRIPTION OF THE PREFERRED EMBODIMENTS

63. Referring now to the drawings, and more particularly to FIGS. 1-17, there are shown preferred embodiments of the method and structures according to the present invention.

64. First Embodiment

65. FIGS. 1 and 2 are vertical sectional views showing a first embodiment of a knocking writing utensil according to the present invention. In the illustrated embodiment, the invention is applied to a writing utensil which is, for example, a ball-point pen and a writing medium which is, for example, a refill holding ink.

66. A knocking writing utensil 10 includes an external cylinder 12 including of a rear cylinder 14, a front cylinder 16 screwed in the tip of the rear cylinder 14, and a tip fitting 18 screwed in the tip of the front cylinder 16. A refill 20 as a writing medium is inserted and housed in the external cylinder 12 so as to be moved in the axial direction. A spring 22 that is an elastic body is interposed between a step portion 18a formed inside the tip fitting 18 and a spring receiver 20a formed on the refill 20, to apply continuous rearward pressure on the refill 20.

67. The rear end of the refill 20 is inserted into an engagement body 26 so that the engagement body 26 moves inside the external cylinder 12 together with the refill 20. The engagement body 26 includes on its circumferential surface, an engagingly-locking protrusion 26a protruding in the direction of the outer diameter. The circumferential surface of the engagement body 26 has a U-shaped hole 26b that is a slit surrounding the engagingly-locking protrusion 26a in three directions, as shown in FIGS. 3(a) to 3(b). The U-shaped hole 26b allows the engagingly-locking protrusion 26a to bend in a radially inward direction. In addition, the top of the engagingly-locking protrusion 26a has an inclined surface 26c, the height of which gradually decreases toward its front end.

68. The rear end of the engagement body 26 is slidably inserted into the knock bar 25. The knock bar 25 has, formed on its tip, a cam portion 25a that can abut the engagingly-locking protrusion 26a of the engagement body 26. The cam portion 25a is shaped to be sharper toward its tip, and both of the sides of cam portion 25a include a first cam surface 25b and a second cam surface 25c.

69. In addition, a plurality of vertical grooves 25d extending in the axial direction are formed on the outer circumferential surface of the knock bar 25. A vertical rib 14a is formed on the corresponding inner circumferential surface of the rear cylinder 14. The vertical grooves 25d and the vertical rib 14a are fitted together, to prevent the knock bar 25 from rotating relative to the external cylinder 12. The rear end of the knock bar 25 is integrated with the knock body 24, and the knock body 24 protrudes rearward from the rear cylinder 14 so as to be exposed outwardly. The knock body 24 and the knock bar 25 may also be separate and distinct parts.

70. A proximal end 28a of a clip 28 is fitted on the rear of the outer circumference of the external cylinder 12, while an engaging-lock receiving protruding portion 28b protruding toward the external cylinder 12 is formed on the back surface of a non-proximal end of the clip 28. As shown in FIG. 4(a), the engaging-lock receiving protruding portion 28b has an inclined surface 28c, formed on its rear, that is inclined so that its height gradually decreases toward its rear end.

71. In addition, as shown in FIG. 4(b), the engaging-lock receiving protruding portion 28b has at its front end a cam surface 28d that is inclined so that its width gradually decreases toward its front end. The cam surface 28d has connected to its rear end an engaging-lock receiving portion 28e that is open in a forward direction for accommodating the engagingly-locking protrusion 26a.

72. A guide hole 12a is formed, on the outer circumferential surface of the external cylinder 12 on rear cylinder 14, corresponding to the engaging-lock receiving protruding portion 28b. As shown in FIG. 5, the guide hole 12a is wider than the engaging-lock receiving protruding portion 28b (shown by an imaginary line) in only one lateral side of the hole relative to the engaging-lock receiving protruding portion 28b. The guide hole 12a has at its rear end (e.g., the narrower end) a cam surface 12b that gradually approaches a side where the engaging-lock receiving protruding portion 28b exists, toward the rear end of the surface 12b.

73. The engagingly-locking protrusion 26a of the engagement body 26 penetrates the guide hole 12a. In addition, the tip of the cam portion 25a of the knock bar 25 is set to be located on an axial line defining the boundary between the engaging-lock receiving portion 28e and the cam surface 28d as shown in FIG. 6 (d). The first cam surface 25b is located on the cam surface 28d side relative to the boundary, while the second cam surface 25c is located on the engaging-lock receiving portion 28e side.

74. An operation of the knocking writing utensil according to the first embodiment and configured in this manner will be described with reference to FIGS. 6(a) to 6(f).

75. When the writing utensil is not in use, the refill 20 is subject to rearward pressure exerted by the spring 22 which positions the refill 20 in the withdrawn position completely within the external cylinder 12. In the withdrawn position, the engagingly-locking protrusion 26a of the engagement body 26 abuts the guide hole 12a at the extreme rearward end of the cam surface 12b (e.g., see FIG. 6(a)) to inhibit the engagement body 26 and the refill 20 from moving further rearward.

76. Next, in a writing operation, the user knocks the knock body 24 forward in order to use the refill 20. The first cam surface 25b of the cam portion 25a of the knock bar 25 abuts the engagingly-locking protrusion 26a to push it forward (e.g., see FIG. 6(b)). The engagingly-locking protrusion 26a contacts the engaging-lock receiving protruding portion 28b of the clip 28, but can pass the engaging-lock receiving protruding portion 28b. This passing is possible because the inclined surface 28c of the engaging-lock receiving protruding portion 28b and the inclined surface 26c of the engagingly-locking protrusion 26a permit a sliding movement of the two parts while in contact. The engagingly-locking protrusion 26a uses its flexibility to slide into the external cylinder 12 along the inclined surface 28c.

77. The first cam surface 25b prevents the engagingly-locking protrusion 26a from being diverted in a lateral direction and from escaping from the engaging-lock receiving protruding portion 28b. The engagingly-locking protrusion 26a moves directly forward in the axial direction to pass the engaging-lock receiving protruding portion 28b.

78. After passing the engaging-lock receiving protruding portion 28b, the engagingly-locking protrusion 26a reaches the front end of the guide hole 12a (e.g., see FIG. 6(c)).

79. When the user reduces the force applied to the knock body 24, the spring 22 moves the refill 20 and the engagement body 28 rearward. The engagingly-locking protrusion 26a is guided by the first cam surface 25b of the cam portion 25a of the knock bar 25 to move straight and rearward in the axial direction without diverting laterally. The engagingly-locking protrusion 26a then abuts on the cam surface 28d of the engaging-lock receiving protruding portion 28b, and then slides on the surface 28d while maintaining contact therewith.

80. The engagingly-locking protrusion 26a then reaches the engaging-lock receiving portion 28e to engage therewith (e.g., see FIG. 6(d)). This engagement prohibits the rearward movement of the refill 20 to hold it at the forward position at which its tip protrudes from the tip of the external cylinder 12. Thus, the writing utensil is ready for use.

81. After using the writing instrument as discussed above, when the user knocks the knock body 24 again, the second cam surface 25c of the cam portion 25a of the knock bar 25 abuts on the engagingly-locking protrusion 26a to push it forward. This operation causes the engagingly-locking protrusion 26a to leave the engaging-lock receiving portion 28e and then to slide on the second cam surface 25c of the cam portion 25a of the knock bar 25 while maintaining contact with surface 25c.

82. In this manner, the engagingly-locking protrusion 26a moves to a side laterally opposite to a side where the engaging-lock receiving protruding portion 28b exists (e.g., see FIG. 6(e)). When the user stops applying force to the knock body 24, the engagingly-locking protrusion 26a moves rearward by passing through a neighborhood of the engaging-lock receiving protruding portion 28b, and then abuts on the cam surface 12b. The engagingly-locking protrusion 26a slides along in contact with the cam surface 12b to return to the rearmost end of this surface. Thus, the refill 20 returns to the withdrawn position and is housed in the external cylinder 12 (e.g., see FIG. 6(f)).

83. Since the proximal end 28a of the clip 28 is fixed to the external cylinder 12, the clip 28 does not move in response to the knocking of the knock body 24 and the knocking operation of the knock body 24 is possible despite the gripping of the clip 28, thereby improving operability.

84. Further, the knock body 24 is knocked to return the refill 20 to the withdrawn position. That is, the forward and the withdrawn positions can be switched by simply knocking the knock body 24, thereby further improving operability.

85. In addition, during the forward movement, in which force is applied to the knock body 24, the engagingly-locking protrusion 26a of the engagement body 26 is forced to slide under the engaging-lock receiving protruding portion 28b of the clip 28 which creates resistance detectable by the operator in confirmation of this operation.

86. Conversely, when no force is applied to the knock body 24 being moved rearwardly, the engagingly-locking protrusion 26a passes through a section of the engaging-lock receiving protruding portion 28b of the clip 28. Consequently, the engagingly-locking protrusion 26a operates smoothly without being stopped in its movement prior to reaching the rearmost end.

87. If the user forgets to house the refill 20 in the withdrawn position, and the refill 20 is in the forward position, when the user moves the external cylinder 12 away from the non-proximal end of the clip 28 to put the writing utensil in a pocket, then the engaging-lock receiving portion 28e and the engagingly-locking protrusion 26a are disengaged from each other. This causes the refill 20 to be automatically moved rearward to the withdrawn position due to the force exerted by the spring 22. This operation and structure of the invention can prevent ink from staining the pocket if a user tries to clip the writing instrument without withdrawing the writing tip.

88. The engagingly-locking protrusion 26a protruding from the guide hole 12a in the external cylinder 12, in the direction of the outer diameter, can be bent in the radially inward direction. Accordingly, during assembly, this flexibility can be used to press the engagement body 26 in from the front of the rear cylinder 14 in order to assemble it into the cylinder 14.

89. Second Embodiment

90. Referring to FIGS. 7 to 12, a second embodiment of the invention will be described below.

91. A knocking writing utensil 30 includes an external cylinder 32 including of a rear cylinder 34, a front cylinder 36 fitted (e.g., screwed) into the tip of the rear cylinder 34, and a tip fitting 38 screwed into the tip of the front cylinder 36. A refill 40, as a writing medium, is inserted and housed in the external cylinder 32 so as to be moved in the axial direction. A spring 42 that is an elastic body is interposed between a step portion 38a formed inside the tip fitting 38 and a spring receiver 40a formed on the refill 40 in order to apply constant tension on the refill 40 in a rearward direction.

92. The rear end of the refill 40 is inserted into an engagement body 46 so that the engagement body 46 moves inside the external cylinder 32 together with the refill 40. The engagement body 46 has, formed on its circumferential surface, an engagingly-locking protrusion 46a. The engagingly-locking protrusion 46a protrudes in the direction of the outer diameter, and has a U-shaped hole 46b formed in the circumferential surface that is a slit surrounding the engagingly-locking protrusion 46a in a plurality (e.g., three) directions, as shown in FIG. 9(b). The U-shaped hole 46b enables the engagingly-locking protrusion 46a to bend in a radially inward direction.

93. In addition, a cam receiving portion 46d is formed behind the engagingly-locking protrusion 46a of the engagement body 46 and away from the engagingly-locking protrusion 46a through approximately ±90°, as seen from the circumferential direction. The cam receiving portion 46d engages a cam portion 45a of a knock bar 45. The cam receiving portion 46d has first and second cam surfaces, 46d1 and 46d2, that each form an inclined surface, and a recessed portion 46d3 formed at the intersection between the first and second cam surfaces 46d1 and 46d2.

94. The rear end of the engagement body 46 is slidably inserted into the knock bar 45. The knock bar 45 has formed at its tip the cam portion 45a that engages with the cam receiving portion 46d of the engagement body 46, as shown in FIG. 10(a) in detail.

95. The cam portion 45a has first and second cam surfaces, 45a1 and 45a2, that each form an inclined surface and a top 45a3 located at the intersection between the first and second cam surfaces 45a1 and 45a2 and shaped to be sharper toward the tip. In addition, a plurality of vertical ribs 45d extending in the axial direction are formed in the outer circumferential surface of the knock bar 45, and vertical grooves 34a are formed on the corresponding inner circumferential surface of the rear cylinder 34. Thus, the vertical ribs 45d and the vertical grooves 34a are fitted together to prevent the knock bar 45 from rotating relative to the external cylinder 32.

96. The rear end of the knock bar 45 is pressed into the knock body 44 so as to integrate the knock bar 45 with the knock body 44, and the knock body 44 protrudes rearward from the rear cylinder 34 so as to be exposed outwardly. A spring 47 is interposed between the knock body 44 and the engagement body 46 to urge them so as to space them in the axial direction.

97. A proximal end 48a of a clip 48 is fitted on the rear of the outer circumference of the external cylinder 32. The clip 48 may include one piece (e.g., be integrally formed) as in the first embodiment, but according to the second embodiment, includes a clip body 49 preferably made of metal and a plastic clip decoration 50 attached to a non-proximal end of the clip body 49. An engaging-lock receiving protruding portion 48b protruding toward the external cylinder 32 is formed on the back surface of the clip decoration 50. The engaging-lock receiving protruding portion 48b has, formed in its rear, an inclined surface 48c that is inclined such that its height gradually decreases toward its rear end (FIG. 8).

98. In addition, as shown in FIG. 11, the engaging-lock receiving protruding portion 48b has at its front end a cam surface 48d that is inclined such that its width gradually decreases toward its front end. The cam surface 48d has connected to its rear end an engaging-lock receiving portion 48e that is open forwardly and that can accommodate the engagingly-locking protrusion 46a. In addition, as shown in FIG. 11, recessed portions 50a for receiving a protruding portion 49a of the clip body 49 are formed in both sides of the rear surface of the clip decoration 50.

99. A guide hole 32a is formed on the outer circumferential surface of the external cylinder 32 at the rear cylinder 34 so as to correspond to the engaging-lock receiving protruding portion 48b. As shown by the dotted line in FIG. 7, the guide hole 32a is wider than the engaging-lock receiving protruding portion 48b (e.g., shown by an imaginary line) in only one lateral side of the hole relative to the engaging-lock receiving protruding portion 48b. The guide hole 32a has at its rear end a cam surface 32b that gradually approaches a side where the engaging-lock receiving protruding portion 48b exists, toward the rear end of the surface 32b.

100. The engagingly-locking protrusion 46a of the engagement body 46 penetrates the guide hole 32a. In addition, the top 45a3 of the cam portion 45a of the knock bar 45 is set to be located on the same axial line as the recessed portion 46d3 when the refill 40 is at the withdrawal position at which it is inside the external cylinder 32.

101. An operation of the knocking writing utensil according to the second embodiment and configured in this manner will be described with reference to FIG. 12.

102. When the writing utensil is not in use, the refill 40 is under tension in a rearward direction by the spring 42. This keeps the refill 40 in the withdrawn position in which it is entirely housed in the external cylinder 32. At this time, the engagingly-locking protrusion 46a of the engagement body 46 abuts the guide hole 32a at the rearmost end of the cam surface 32b (e.g., see FIG. 12(a)) to inhibit the engagement body 46 and the refill 40 from moving further rearward.

103. Next, when the user knocks the knock body 44 forward in order to use the refill 40, the top 45a3 of the cam portion 45a of the knock bar 45 engages the recessed portion 46d3 of the cam receiving portion 46d of the engagement body 46 to push the engagement body 46 forward (e.g., see FIG. 12(b)). The engagingly-locking protrusion 46a of the engagement body 46 interferes with (e.g., abuts) the engaging-lock receiving protruding portion 48b of the clip 48, but can pass the engaging-lock receiving protruding portion 48b. The engagingly-locking protrusion 46a can slide past the engaging-lock receiving protruding portion 48b by sliding on the inclined surface 48c of the engaging-lock receiving protruding portion 48b.

104. Contact is maintained between the engagingly-locking protrusion 46a and the engaging-lock receiving protruding portion 48b as the engagingly-locking protrusion 46a slides past the engaging-lock receiving protruding portion 48b. Due to its flexibility, the engagingly-locking protrusion 46a slides into the external cylinder 32 along the inclined surface 48c. As the top 45a3 of the cam portion 45a is engaged with the recessed portion 46d3 of the cam receiving portion 46d, the engagingly-locking protrusion 46a is prevented from being diverted in the lateral direction.

105. Therefore as a result, the engagingly-locking protrusion 46a moves straight forwardly in the axial direction to pass the engaging-lock receiving protruding portion 48b. After passing the engaging-lock receiving protruding portion 48b, the engagingly-locking protrusion 46a reaches the front end of the guide hole 32a (e.g., see FIG. 12(c)).

106. When the user reduces the force applied to the knock body 44, the spring 42 moves the refill 40 and the engagement body 46 rearwardly. While the top 45a3 of the cam portion 45a of the knock bar 45 remains engaged with the recessed portion 46d3, the engagingly-locking protrusion 46a moves rearwardly in a straight line in the axial direction without being diverted laterally and abuts the cam surface 48d of the engaging-lock receiving protruding portion 48b.

107. When the force applied to the knock body 44 is further reduced, the recessed portion 46d3 of the engagement body 46 and the top 45a3 of the cam portion 45a are disengaged from each other. This disengagement causes the engagingly-locking protrusion 46a to slide on the cam surface 48d while maintaining contact therewith. The engagingly-locking protrusion 46a then reaches the engaging-lock receiving portion 48e to engage it (e.g., see FIG. 12(d)). This engagement prohibits the rearward movement of the refill 40 and holds it at the forward position where its tip protrudes from the tip of the external cylinder 32.

108. As a result of the operation above, the writing utensil is ready for use. The knock body 44 is returned to its rearward position because of the tension supplied by the spring 47.

109. When the user knocks the knock body 44 when the writing utensil is ready for use, the first cam surface 45a1 of the cam portion 45a of the knock bar 45 abuts the first cam surface 46d1 of the cam receiving portion 46d of the engagement body 46 to push it forward. This operation causes the engagingly-locking protrusion 46a of the engagement body 46 to disengage from the engaging-lock receiving portion 48e, and then to move to a side laterally opposite to a side of the engaging-lock receiving protruding portion 48b (e.g., see FIG. 12(e)).

110. When the user stops applying force to the knock body 44, the engagingly-locking protrusion 46a moves rearwardly through the section with the engaging-lock receiving protruding portion 48b, and then abuts on the cam surface 32b. The engagingly-locking protrusion 46a slides on the cam surface 32b and maintains contact with the cam surface 32b to return to the rear most end of this surface (e.g., see FIG. 12(f)). Thus, the refill 40 returns to the withdrawal position and is housed in the external cylinder 32.

111. The above configuration provides benefits similar to those of the first embodiment. In addition, according to the second embodiment, the cam receiving portion 46d is formed separately from the engagingly-locking protrusion 46a, so that the cam portion 45a of the knock bar 45 can guide the engagement body 46 stably.

112. Third Embodiment

113. Referring to FIGS. 13 and 14, a third embodiment of the invention will be described below.

114. Although the first and second embodiments have been described in conjunction with the rear-end knocking writing utensil in which the knock bodies (e.g., 24 and 44, respectively) protrude from the rear end of the external cylinders (e.g., 12 and 32, respectively), the third embodiment of the invention differs in that it includes a knock body on the side of an external cylinder. The knock body can be knocked in the radial direction or slidably knocked in the axial direction. Thus, the third embodiment is directed to a side knock writing utensil.

115. A side knock writing utensil 60 includes an external cylinder 62 including a front cylinder 66 screwed in the tip of the rear cylinder 34 and a tip fitting 68 screwed in the tip of the front cylinder 66. A refill 70, as a writing medium, is inserted and housed in the external cylinder 62, and the refill 70 moves in the axial direction. A spring 72 that is an elastic body is interposed between a step portion 66a formed inside the front cylinder 66 and the front end of a refill receiver 71. The rear end of the refill 70 is inserted into the refill receiver 71 such that the refill receiver 71 and the refill 70 are integrated together. The spring 72 constantly urges the refill 70 and the refill receiver 71 rearwardly.

116. The refill receiver 71 has, formed in its front, a knock receiving portion 71a the diameter of which is increased relative to the refill receiver and that has a rear end surface acting as a cam surface. In addition, a swingable knock body 74 is attached to the circumferential surface of the front cylinder 66. When the knock body 74 is knocked from the side and is swung into the front cylinder 66, the cam surface of the knock receiving portion 71a is pushed forward.

117. An engagement body 76 abuts the rear end of the refill receiver 71, so that the refill receiver 71 and the refill 70 can be positioned by adjusting the position of the engagement body 76. As shown in the enlarged view in FIG. 14, the engagement body 76 has, on its circumferential surface, an engagingly-locking protrusion 76a, a U-shaped hole 76b, and a cam receiving portion 76d that are identical to the engagingly-locking protrusion 46a, the U-shaped hole 46b, and the cam receiving portion 46d according to the second embodiment of the invention.

118. The engagingly-locking protrusion 76a can be bent in the radially inward direction. The cam receiving portion 76d also has first and second cam surfaces 76d1 and 76d2, each including an inclined surface, and a recessed portion 76d3 formed at the intersection between the first and second cam surfaces 76d1 and 76d2, as in the second embodiment.

119. The rear end of the refill receiver 71 is coupled to the knock bar 75. The knock bar 75 has formed thereon a cam portion 75a that engages the cam receiving portion 76d of the engagement body 76. This configuration is the same as the cam portion 45a of the knock bar 45 in the second embodiment.

120. The cam portion 75a has first and second cam surfaces, 75a1 and 75a2, that each include an inclined surface, and a top 75a3 located at the intersection between the first and second cam surfaces 75a1 and 75a2 and shaped to be sharper toward the tip. In addition, a plurality of vertical ribs 75d extending in the axial direction are formed in the outer circumferential surface of the knock bar 75, and the vertical ribs 75d are fitted in the corresponding vertical grooves 34a in the rear cylinder 34 to prevent the knock bar 75 from rotating relative to the external cylinder 62.

121. A spring 77 is provided on the inner circumferential surface of the engagement body 76, and is interposed between the engagement body 76 and the refill receiver 71 to urge the engagement body 76 rearward relative to the refill receiver 71, (e.g., toward the knock bar 75). Thus, the spring 77 serves to urge the cam receiving portion 76d of the engagement body 76 so as to abut it on the cam portion 75a. The spring 77 is selected to have a weaker spring force than the spring 72.

122. A rear-end cap 78 is attached to the rear end of the external cylinder 62. The clip 48 is fitted in the rear of the outer circumference of the external cylinder 62. The clip 48 and the guide hole 62a in the outer circumferential surface of the external cylinder 62 are the same as in the second embodiment, so its detailed description is omitted.

123. The operation of the side knock writing utensil according to the third embodiment and configured in this manner is also similar to the operation of the second embodiment of the invention described in the preceding sections.

124. When the user knocks the knock body 74, to move the refill 70 forward into a writing position, the knock body 74 moves the refill receiver 71 forward which in turn moves forward the knock bar 75 coupled to the refill receiver 71. This permits the cam portion 75a of the knock bar 75 and the cam receiving portion 76d of the engagement body 76 to perform the same operations as shown in FIGS. 12(a) to 12(d) referred to with respect to the second embodiment.

125. Thus, the engagingly-locking protrusion 76a of the engagement body 76 engages the engaging-lock receiving portion 48e, and the engagement body 76 prohibits the refill 70 from moving rearwardly. As a result, the refill 70 is held at the forward position at which its tip protrudes from the tip of the external cylinder 62.

126. After the writing operation is finished, when the user knocks the knock body 74 again for withdrawing the writing tip into the body of the writing instrument, the knock body 74 moves the refill receiver 71 forward which moves forward the knock bar 75 coupled to the refill receiver 71. This operation permits, the cam portion 75a of the knock bar 75 and the cam receiving portion 76d of the engagement body 76, to perform the same operations as shown in FIGS. 12(e) to 12(f).

127. Thus, the refill 70 returns to the withdrawn position where its tip has retreated behind the tip of the external cylinder 62 so as to be completely housed in the external cylinder 62. These operations provide benefits similar to those described in the preceding embodiments.

128. Fourth Embodiment

129. Referring to FIGS. 15 to 17, a fourth embodiment of the present invention will be described below.

130. In these figures, the same members as in the embodiments of the invention described previously have the same reference numerals, and their detailed description is omitted. The fourth embodiment differs from the above embodiments in that it is a side knock writing utensil and requires a smaller number of parts than the third embodiment of the invention.

131. An engagement body 86 in a knocking writing utensil 80, according to a fourth embodiment of the invention, has an engagingly-locking protrusion 86a, a U-shaped hole 86b, and a slit 86c located 180° away from the engagingly-locking protrusion 86a in the circumferential direction. The slit 86c fits the engagement body 86 on the rear end of the refill receiver 81 so that the engagement body 86 can be moved inside the external cylinder 82 integrally with the refill receiver 81 which supports the rear end of the refill 70. As a result, the knock bar 75 and the spring 77 can be omitted.

132. In addition, as shown in FIG. 16, the guide hole 82a in the external cylinder 82 is wider than the engaging-lock receiving protruding portion 48b (e.g., shown by an imaginary line) in only one lateral side of the hole relative to the engaging-lock receiving protruding portion 48b.

133. The guide hole 82a has, formed at its rear end, a rear-end cam surface 82b that gradually approaches a side where the engaging-lock receiving protruding portion 48b exists, toward the rear end of the surface 82b. In addition, the guide hole 82a has at its front end, a front-end first cam surface 82c that gradually approaches a side where the engaging-lock receiving protruding portion 48b is not formed, toward the front end of the cam surface 82b, as well as a front-end second cam surface 82d connected to the front-end first cam surface 82c.

134. In the side knock writing utensil configured in this manner, when the user knocks the knock body 74 to move the refill 70 forward. The knock body 74 moves the refill receiver 81 forward which in turn moves forward the engagement body 86 coupled to the rear end of the refill receiver 81.

135. This operation induces a cooperative operation between the engagingly-locking protrusion 86a of the engagement body 86 and the engaging-lock receiving protruding portion 48b, as shown in the left half of FIGS. 12(a) to 12(d). Then, the engagingly-locking protrusion 86a moves, as shown by the arrow in FIG. 16, and engages with the engaging-lock receiving portion 48e. In this manner, the refill 70 is held at a forward position in which its tip protrudes from the tip of the external cylinder 82.

136. After using the writing instrument with the refill 70 in a forward position, when the user knocks the knock body 74, the knock body 74 moves the refill receiver 71 forwardly. The forward movement of the refill receiver 71 moves forward the engagement body 86 coupled to the refill receiver 71. Then, as shown by the arrow in FIG. 16, the engagingly-locking protrusion 86a of the engagement body 86 leaves the engaging-lock receiving portion 48e, reaches the front-end second cam surface 82d. The engagingly-locking protrusion 86a slides on the second cam surface 82d and maintaining contact therewith moves to the side laterally opposite to the side with the engaging-lock receiving protruding portion 48b.

137. When the user stops applying force to the knock body 74, the engagingly-locking protrusion 86a moves rearwardly passing through the section where the engaging-lock receiving protruding portion 48b is located, and then abuts the rear-end cam surface 82b. The engagingly-locking protrusion 86a slides on the rear-end cam surface 82b while maintaining contact therewith to return to the rearmost end of this surface. Thus, the refill 70 returns to the withdrawn position and is housed in the external cylinder 82.

138. To perform this withdrawal operation reliably, the boundary between the front-end first and second cam surfaces, 82c and 82d, is formed closer to the lateral side where the engaging-lock receiving protruding portion 48b exists than to the side opposite to the engaging-lock receiving portion 48e.

139. As described above, the fourth embodiment provides all the benefits of the embodiments of the invention described previously and additionally further reduces the number of required parts, thereby simplifying the structure of the invention.

140. Although the above examples have been shown in conjunction with the application of the invention to a ball-point pen as a writing utensil, the invention is not limited to this application. The invention is also applicable to a mechanical pencil wherein a lead delivery mechanism is used as a writing medium to allow the knock body to move the lead delivery mechanism from the withdrawal position to the forward position. This invention can also be applied to a “magic marker” using, as a writing medium, a holder that contains and holds ink or a felt core.

141. Furthermore, although in the above embodiments, the engagement body, the refill, and the refill receiver are separate from one another, this invention is not limited thereto and the writing medium and the engagement body can be integrally formed as one piece.

142. As described above, the proximal end of the clip is fixed to the external cylinder to prevent the clip from moving in response to the knocking of the knock body while enabling the knock body to be operated despite the gripping of the clip, thereby improving operability.

143. In addition, as with typical knocking writing utensils, the writing medium can be switched between the forward and withdrawal positions by simply knocking the knock body, thereby further improving operability. Also, if the user attempts to house the writing utensil in a pocket with the writing medium still fixed at the forward position, then as soon as the non-proximal end of the clip is moved, the engagingly-locking protrusion and the engaging-lock receiving portion are disengaged from each other. This disengagement permits the writing medium to return to the withdrawal position. This operation and feature of the invention can prevent the writing medium from staining or damaging a user's pocket and clothing.

144. While the invention has been described in terms of several preferred embodiments those skilled in the art will recognize that the invention can be practiced with modification within the spirit and scope of the appended claims.

Having thus described our invention, what we claim as new and desire to secure by Letters Patent is as follows:

1. A knocking writing utensil comprising:
an external cylinder having a guide hole formed therein;
a writing medium housed in the external cylinder so as to be movable in an axial direction;
an elastic body for urging the writing medium rearwardly;
a knock body exposed outwardly from the external cylinder to be knocked, wherein the knock body operates to move the writing medium between a withdrawal position at which the writing medium is withdrawn into said external cylinder and a forward position at which a tip of said writing medium protrudes from a tip of said external cylinder;
a clip with its proximal end fixed to said external cylinder;
an engagement body, provided within said external cylinder, for positioning the writing medium;
an engagingly-locking protrusion formed on said engagement body;
an engaging-lock receiving protruding portion including an engaging-lock receiving portion at its front end being formed on a back surface of a non-proximal end of said clip, said guide hole being formed in the external cylinder so as to correspond to said engaging-lock receiving protruding portion of the clip, wherein the guide hole is wider than said engaging-lock receiving protruding portion in only one lateral side of the guide hole relative to said engaging-lock receiving protruding portion, wherein said engagingly-locking protrusion is engaged with said engaging-lock receiving portion through said guide hole to hold the writing medium at the forward position and is disengaged from said engaging-lock receiving portion and placed behind said engaging-lock receiving protruding portion to hold the writing medium at the withdrawal position; and
a knock bar, disposed inside said external cylinder, being integratedly operated with the knock body and including a cam portion,
said cam portion being engageable with said engagement body,
said cam portion guiding said engagingly-locking protrusion beyond said engaging-lock receiving protruding portion from behind it to said engaging-lock receiving portion and guiding said engagingly-locking protrusion from said engaging-lock receiving portion to behind said engaging-lock receiving protruding portion so as to pass by one lateral side of said engaging-lock receiving protruding portion.

2. The knocking writing utensil according to claim 1, wherein said cam portion of said knock bar is engageable with said engagingly-locking protrusion of said engagement body, and comprises:
a first cam surface that guides said engagingly-locking protrusion beyond said engaging-lock receiving protruding portion from behind it to said engaging-lock receiving portion; and
a second cam surface that guides said engagingly-locking protrusion from the engaging-lock receiving portion to behind the engaging-lock receiving protruding portion in such a way as to pass by one lateral side of the engaging-lock receiving protruding portion.

3. The knocking writing utensil according to claim 1, wherein said engagement body further comprises a cam receiving portion that engages said cam portion of said knock bar.

4. The knocking writing utensil according to claim 1, wherein said engagement body includes a slit formed therein for bending said engagingly-locking protrusion in a direction of an inner diameter.

5. The knocking writing utensil according to claim 2, wherein said engagement body includes a slit formed therein for bending the engagingly-locking protrusion in a direction of an inner diameter.

6. The knocking writing utensil according to claim 3, wherein said engagement body includes a slit formed therein for bending the engagingly-locking protrusion in a direction of an inner diameter.

7. The knocking writing utensil according to claim 5, wherein the engaging-lock receiving protruding portion includes an inclined surface that is inclined such that its height gradually decreases toward its rear end, and
wherein the engagingly-locking protrusion includes an inclined surface that is inclined such that its height gradually decreases toward its frond end.

8. The knocking writing utensil according to claim 6, wherein the engaging-lock receiving protruding portion includes an inclined surface that is inclined such that its height gradually decreases toward its rear end, and
wherein the engagingly-locking protrusion includes an inclined surface that is inclined such that its height gradually decreases toward its frond end.

9. The knocking writing utensil according to claim 6, wherein the engaging-lock receiving protruding portion includes an inclined surface that is inclined such that its height gradually decreases toward its rear end, and
wherein the engagingly-locking protrusion includes an inclined surface that is inclined such that its height gradually decreases toward its frond end.

10. A knocking writing utensil, comprising
an external cylinder;
a writing medium housed in the external cylinder so as to be movable in an axial direction;
an engagement body, provided in the external cylinder, for positioning the writing medium;
an elastic body for urging the writing medium rearwardly; and
a knock body exposed outwardly from said external cylinder to be knocked, wherein the knock body operates to move the writing medium between a withdrawal position at which it is withdrawn into the external cylinder and a forward position at which its tip protrudes from the tip of an external cylinder.

11. The knocking writing utensil according to claim 10, wherein said engagement body includes a slit formed therein for bending the engagingly-locking protrusion in the direction of the inner diameter.

12. The knocking writing utensil according to claim 10, further comprising:
a first spring provided on an inner circumferential surface of said engagement body to urge said engagement body rearwardly away from a writing tip; and
a second spring provided to apply tension on said writing medium in a rearward direction away from said writing tip,
wherein said first spring is selected to have a weaker spring force than said second spring.

13. The writing utensil according to claim 10, wherein said knock body comprises a side knocking body.

14. The writing utensil according to claim 10, further comprising a clip coupled to said external cylinder and including an engaging-lock receiving protruding portion,
wherein a guide hole is formed in the external cylinder so as to correspond to the engaging-lock receiving protruding portion of the clip, and
wherein the guide hole is wider than the engaging-lock receiving protruding portion in only one lateral side of the hole relative to the engaging-lock receiving protruding portion.

15. The writing utensil according to claim 14, further comprising an engagingly-locking receiving portion engaged with said engagingly-locking protrusion,
wherein said engagingly-locking protrusion is engaged with said engaging-lock receiving portion through said guide hole to hold the writing medium at a first position, and is disengaged from said engaging-lock receiving portion and placed behind the engaging-lock receiving protruding portion to hold the writing medium in a second position.

16. The writing utensil according to claim 15, wherein said knock bar includes a cam portion engageable with the engagement body,
said cam portion guiding said engagingly-locking protrusion beyond said engaging-lock receiving protruding portion from behind it to said engaging-lock receiving portion and guiding said engagingly-locking protrusion from said engaging-lock receiving portion to behind said engaging-lock receiving protruding portion so as to pass by one lateral side of said engaging-lock receiving protruding portion.

17. The writing utensil according to claim 16, wherein said cam portion of said knock bar is engageable with said engagingly-locking protrusion of said engagement body, and comprises:
a first cam surface that guides said engagingly-locking protrusion beyond said engaging-lock receiving protruding portion from behind it to said engaging-lock receiving portion; and
a second cam surface that guides said engagingly-locking protrusion from the engaging-lock receiving portion to behind the engaging-lock receiving protruding portion in such a way as to pass by one lateral side of the engaging-lock receiving protruding portion.

18. A knocking writing utensil comprising:
an external cylinder including a guide hole with a front-end cam surface;
a writing medium housed in said external cylinder so as to be moveable in an axial direction;
an elastic body for urging the writing medium rearwardly,
a knock body exposed outwardly from a side of said external cylinder to be knocked,
wherein said knock body operates to move the writing medium between a first position and a second position;
a clip with its proximal end fixed to said external cylinder;
an engagement body, provided in the external cylinder for positioning the writing medium;
an engagingly-locking protrusion formed on said engagement body; and
an engaging-lock receiving protruding portion including an engaging-lock receiving portion at its front end formed on a back surface of a non-proximal end of the clip.

19. The knocking writing utensil according to claim 18, wherein said guide hole corresponding to the engaging-lock receiving protruding portion of the clip, and
wherein said guide hole is wider than the engaging-lock receiving protruding portion in only one lateral side of the guide hole relative to the engaging-lock receiving protruding portion.

20. The knocking writing utensil according to claim 18, wherein said front-end cam surface of the guide hole being located at a front end of the guide hole opposed to the engaging-lock receiving portion, and
wherein the front-end cam surface gradually approaches a side where the engaging-lock receiving protruding portion does not exist, toward the front end of the cam surface.

21. The knocking writing utensil according to claim 18, wherein said engagingly-locking protrusion engages with said engaging-lock receiving portion through said guide hole to hold the writing medium at the first position and disengages from the engaging-lock receiving portion and is placed behind said engaging-lock receiving protruding portion to hold the writing medium at the second position.

22. The knocking writing utensil according to claim 18, wherein said knock body is knocked to move forward the writing medium located at said second position to move said engagingly-locking protrusion beyond said engaging-lock receiving protruding portion from behind it to said engaging-lock receiving portion.

23. The knocking writing utensil according to claim 18, wherein said knock body is knocked to move forward the writing medium located at said first position to cause said engagingly-locking protrusion to depart from said engaging-lock receiving portion and then to slide on said front-end cam surface to move said engagingly-locking protrusion to behind said engaging-lock receiving protruding portion so as to pass by a lateral side of said engaging-lock receiving protruding portion.

24. The knocking writing utensil according to claim 18, wherein said engaging-lock receiving protruding portion has in its rear an inclined surface that is inclined such that its height gradually decreases toward its rear end, and
wherein said engagingly-locking protrusion has at its top an inclined surface that is inclined such that its height gradually decreases toward its frond end.

25. The knocking writing utensil according to claim 18, wherein said first position comprises a forward position of said writing medium and said second position comprises a withdrawn position of said writing medium.
